(19) United States
(12) Patent Application Publication
(10) Pub. No.: US 2012/0133290 A1
(43) Pub. Date: May 31, 2012

(54) IMAGE DISPLAY APPARATUS

(75) Inventor: Tsuyoshi Hasegawa, Nishinomiya City (JP)

(73) Assignee: SANYO ELECTRIC CO., LTD., Osaka (JP)

(21) Appl. No.: 13/303,383

(22) Filed: Nov. 23, 2011

(30) Foreign Application Priority Data
Nov. 25, 2010 (JP) 2010-262618

(51) Int. Cl. H05B 37/02

(52) U.S. Cl. 315/185 R

(57) ABSTRACT

An image display apparatus includes a main body in which a display unit is disposed, and a backlight unit that is detachable from the main body and to which a plurality of LED modules are attached, each of which is provided with LEDs, so that the image display apparatus displays an image on the display unit with backlight light emitted by the LEDs. The plurality of LED modules are assigned with different channels as units of control of light emission luminance of the LEDs and can be replaced independently of each other.

### CROSS-REFERENCE TO RELATED APPLICATIONS

This application is based on Japanese Patent Application No. 2010-262618 filed on Nov. 25, 2010, the contents of which are hereby incorporated by reference.

### BACKGROUND OF THE INVENTION

1. Field of the Invention

The present invention relates to an image display apparatus using LEDs as a light source of a backlight.

2. Description of Related Art

Conventionally, there is widely used an image display apparatus like a liquid crystal display apparatus, which displays an image using a backlight. Further, in recent years, there is developed an image display apparatus using light emitting diodes (LEDs) as a light source of the backlight. Using the LEDs, a long lifetime and low power consumption of the backlight can be realized.

In addition, conventionally, there is proposed a liquid crystal display apparatus using the LEDs as a light source of the backlight. In addition, in the liquid crystal display apparatus, the LEDs are disposed in a light source unit, and further, this light source unit may be replaceable. With this structure, even if a malfunction such as breakdown or deterioration of the LEDs, the malfunction can be resolved by replacing the light source unit (with a new one).

When a plurality of LEDs are disposed in the light source unit, a malfunction may occur only in a part of them. In this case, if the LEDs can be replaced only by a unit of the light source unit, normal LEDs are also replaced wastefully when an LED having a malfunction is replaced.

In addition, like a model performing local dimming, if the light emission luminance of the backlight is adjusted individually for each channel (unit of control of light emission luminance), a use history of an LED is different among channels. From such circumstances, in many cases, a malfunction of the LED such as deterioration or breakdown is apt to occur differently among channels. Therefore, it is preferred that LEDs be replaceable by one channel.

### SUMMARY OF THE INVENTION

An image display apparatus according to the present invention includes a main body in which a display unit is disposed, and a backlight unit that is detachable from the main body and to which a plurality of LED modules are attached, each of which is provided with LEDs, so that the image display apparatus displays an image on the display unit with backlight light emitted by the LEDs. The plurality of LED modules are assigned with different channels as units of control of light emission luminance of the LEDs and can be replaced independently of each other.

### BRIEF DESCRIPTION OF THE DRAWINGS

Objects and features of the present invention will be apparent from the following description of a preferred embodiment with reference to the attached drawings as follows.

FIG. 1 is an external view of an image display apparatus according to an embodiment of the present invention.

FIG. 2 is a cross sectional view of an image display apparatus according to the embodiment of the present invention.

FIG. 3 is an explanatory diagram of a main operational system in the image display apparatus according to the embodiment of the present invention.

FIG. 4 is an external view of a backlight unit according to the embodiment of the present invention.

FIG. 5 is an explanatory diagram of a connection form of light bars according to the embodiment of the present invention.

FIG. 6 is an explanatory diagram of a manner in which the backlight unit is detachable.

FIG. 7 is another external view of the image display apparatus according to the embodiment of the present invention.

FIG. 8 is another explanatory diagram of a manner in which the backlight unit is detachable.

FIG. 9 is an explanatory diagram of a circuit structure of a light bar 4a.

FIG. 10 is an explanatory diagram of a circuit structure of a light bar 4b.

FIG. 11 is an explanatory diagram of a circuit structure of a light bar 4c.

FIG. 12 is an explanatory diagram of a circuit structure of a backlight circuit.

FIG. 13 is an explanatory diagram of a base component of the light bar.

FIG. 14 is an explanatory diagram of a connection between a main body and the backlight unit.

### DETAILED DESCRIPTION OF THE PREFERRED EMBODIMENTS

An embodiment of the present invention will be described below with an example of an image display apparatus.

[General Structure of Image Display Apparatus]

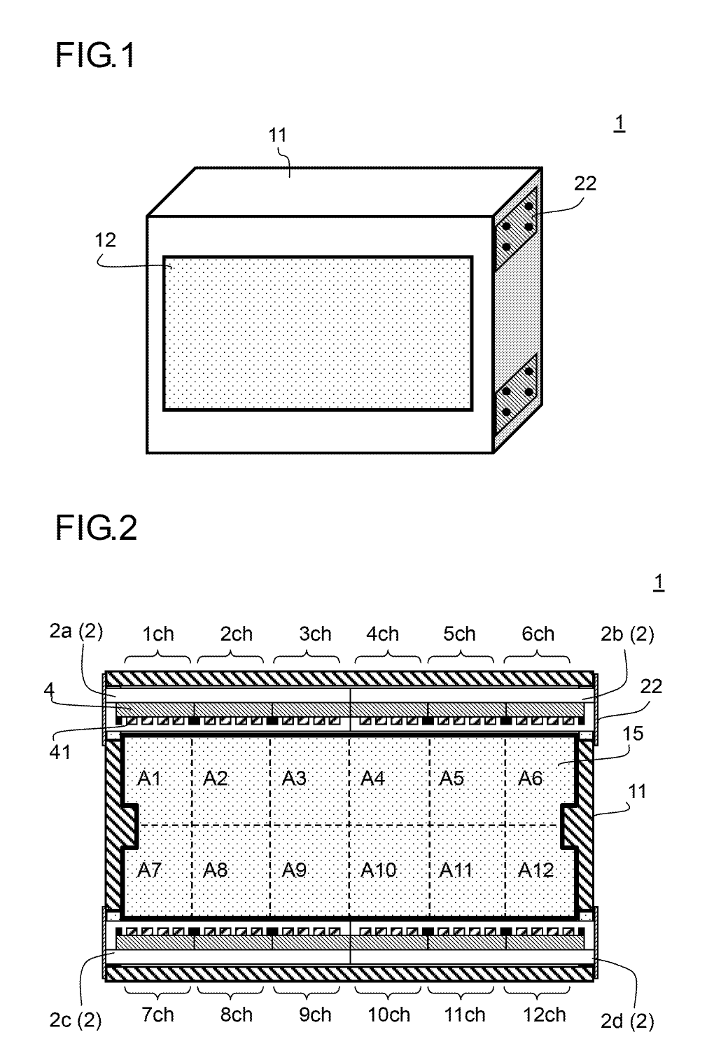

FIG. 1 is an external view of an image display apparatus 1 viewed from the front. As illustrated in this diagram, the image display apparatus 1 includes a housing 11 having a substantially rectangular solid shape. On the front surface of the housing 11, there is disposed a liquid crystal panel 12 (a display unit), which displays an image toward the front side.

The liquid crystal panel 12 has a rectangular shape in a plan view and a structure in which two glass substrates are bonded to each other with a predetermined gap therebetween, and liquid crystal is filled in between the glass substrates. The liquid crystal panel 12 is fixed by a bezel, for example, which is attached to the housing 11.

In addition, on one of the glass substrates, there are disposed switching elements (for example, thin film transistors) connected to source wiring lines and gate wiring lines that cross each other, pixel electrodes connected to the switching elements, an orientation film, and the like. On the other glass substrate, there are disposed a color filter in which coloring portions of red, green, and blue (RGB) colors, or the like are arranged in a predetermined pattern, a common electrode, an orientation film, and the like. In addition, there are further disposed polarizing plates on the outsides of the both substrates.

In each pixel of the liquid crystal panel 12, transmittance for the backlight is adjusted by control of the switching element. In addition, the liquid crystal panel 12 has color pixels of 1920×1080 dots for high definition TV, for example, but other pixel number and pixel type may be adopted.

In addition, there are disposed optical members such as a backlight unit and a light guide plate inside the housing 11. The light guide plate is disposed behind the liquid crystal panel 12 in parallel to the display screen of the liquid crystal panel 12.

FIG. 2 is a cross sectional view of the image display apparatus 1 taken along a plane parallel to the light guide plate. As illustrated in this diagram, a light guide plate 15 is formed in substantially the same size as the liquid crystal panel 12 and is fixed to the housing 11. Viewing in the direction of displaying an image, the display screen of the liquid crystal panel 12 and the light guide plate 15 are overlaid with each other. Then, in vicinities of upper and lower edges of the light guide plate 15, there are disposed four backlight units (2a to 2d; hereinafter may be generically referred to as a “backlight unit 2”) each of which is attached to a light bar 4.

As illustrated in FIG. 2, the backlight unit 2a is disposed at the upper left side of the light guide plate 15, the backlight unit 2b is disposed at the upper right side of the light guide plate 15, the backlight unit 2c is disposed at the lower left side of the light guide plate 15, and the backlight unit 2d is disposed at the lower right side of the light guide plate 15.

Note that each backlight unit 2 is formed as a part (a cartridge) separated from the main body and is detachable from the main body (that indicates a part constituted of the housing 11, the liquid crystal panel 12, and the like, except the backlight unit 2; the same is true in the following description), as illustrated in FIG. 8.

In addition, three light bars 4 are arranged so as to form an array along the edge of the light guide plate 15 and attached to each backlight unit 2. Further, a plurality of LEDs 41 to be a light source of the backlight are aligned on each light bar 4 in the same direction as the alignment direction of the light bars 4 and are connected in series. These points will be described in detail later.

In addition, light emission luminance of the LEDs 41 can be controlled individually for each light bar 4. In other words, the image display apparatus 1 can control light emission luminance of the LEDs 41 by unit of a channel, and the channel is assigned to each of the light bars 4, separately. More specifically, as illustrated in FIG. 2, the channels from 1ch to 12ch are assigned in order from the light bar 4 disposed at the upper left side.

With the structure described above, the backlight unit 2 and the light guide plate 15 form an edge light type (light guide plate type) backlight. In other words, light emitted from the LED 41 enters the light guide plate 15 from a side face (upper surface or lower surface) and emerges from the front face (opposed to the liquid crystal panel 12) of the light guide plate 15 after repeating surface reflection, so that the light is supplied to the liquid crystal panel 12.

Here, the light guide plate 15 is formed so that light emerges more from a position closer to the incident position of light when the light enters the same. Therefore, when the light guide plate 15 is divided into 12 areas from A1 to A12 as illustrated in FIG. 2, the areas correspond to different channels, respectively.

More specifically, an area “An” (n denotes any one of 1 to 12) corresponds to an “nch”. Then, luminance (emerging light intensity) of each area is affected strongly by control of the corresponding channel. For instance, if the light emission luminance in 3ch is controlled to be lower, the area A3 becomes darker mainly. The image display apparatus 1 utilizes this fact to achieve local dimming of the backlight.

In other words, in the image display apparatus 1, the light bars 4 are disposed corresponding to the areas (front surface portions of the areas A1 to A12) of the display screen of the liquid crystal panel 12. Then, the image display apparatus 1 controls the light emission luminance of the LEDs 41 of each light bar 4 so as to adjust luminance of the backlight individually for each area of the display screen of the liquid crystal panel 12.

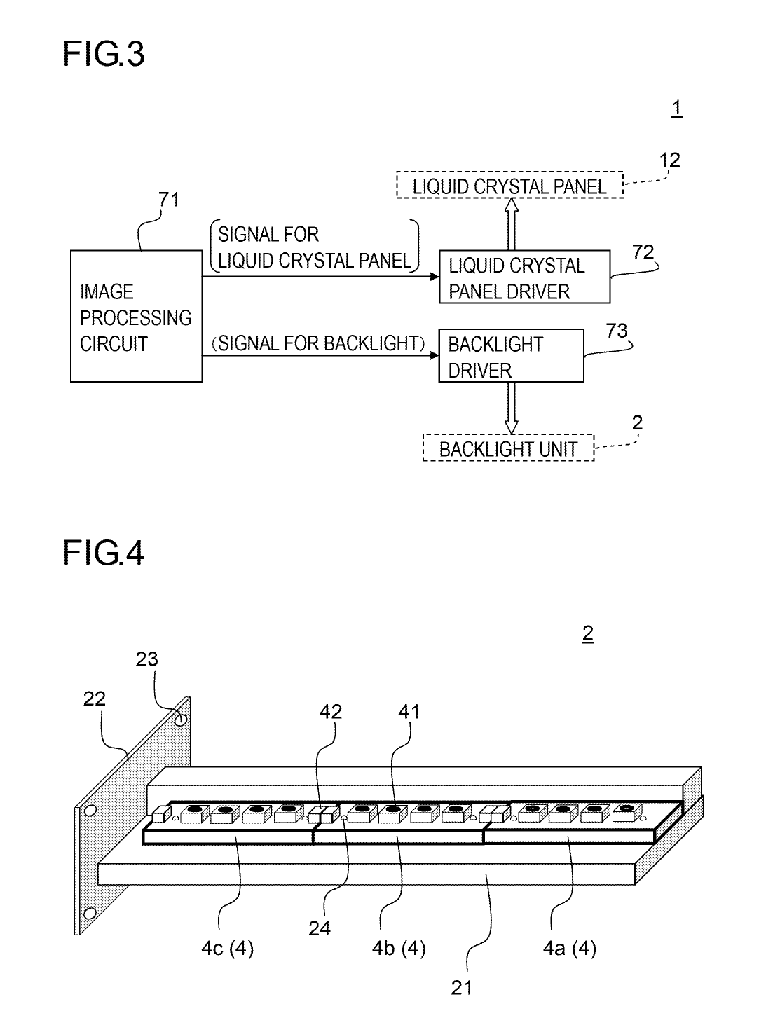

FIG. 3 illustrates a main operational system in the image display apparatus 1. As illustrated in this diagram, the image display apparatus 1 is equipped with an image processing circuit 71, a liquid crystal panel driver 72, a backlight driver 73, and the like in addition to the above-mentioned structure. These are disposed inside the housing 11 in a state mounted on a circuit board, for example.

The image processing circuit 71 obtains information of an image (a moving image or a still image) by predetermined means (for example, by receiving a broadcasting signal). Then, the image processing circuit 71 generates a signal for the liquid crystal panel and a signal for the backlight based on this information so that the image is appropriately displayed. Note that the signal for the liquid crystal panel contains information for specifying a transmittance for the backlight light with respect to each pixel of the liquid crystal panel 12 and is sent to the liquid crystal panel driver 72. In addition, the signal for the backlight contains information for specifying the light emission luminance of each channel and is sent to the backlight driver 73.

Here, the image processing circuit 71 generates these signals so that the local dimming of the backlight is performed. In other words, the image processing circuit 71 generates the signal for the backlight so that backlight luminance (light emission luminance of the LED 41) becomes low for the channel corresponding to a dark part in the image. In addition, the image processing circuit 71 generates the signal for the liquid crystal panel so as to compensate for a variation of luminance of the image due to a decrease of luminance in the backlight. Note that the method of the local dimming itself in the edge light type backlight is known, and therefore detailed description thereof is omitted here.

The liquid crystal panel driver 72 adjusts the transmittance for the backlight light of each pixel of the liquid crystal panel 12 based on the received signal for the liquid crystal panel. In addition, the backlight driver 73 adjusts light emission luminance of the LED 41 for each channel based on the received signal for the backlight. By performing these operations, an image is displayed on the display screen of the liquid crystal panel 12.

[Form of Backlight Unit]

Next, a form of the backlight unit 2 will be described in more detail. FIG. 4 is an external view of the backlight unit 2. Note that FIG. 4 illustrates a shape of the backlight unit 2c disposed at the lower left side of the image display apparatus 1 as a representative, and other backlight units have shapes symmetrical to the shape illustrated in FIG. 4 in accordance with the disposed positions thereof.

In other words, a shape of the backlight unit 2a disposed at the upper left side is symmetrical to the shape of the backlight unit 2c with respect to a horizontal plane. In addition, shapes of the backlight unit 2b and the backlight unit 2d are symmetrical to the shapes of the backlight unit 2a and the backlight unit 2c, respectively, with respect to a vertical plane.

As illustrated in FIG. 4, the backlight unit 2 includes a heat radiation plate 21 having a substantially rectangular solid shape, and on one end surface thereof in a longitudinal direction, a fixing plate 22 is disposed to be parallel to the end surface. The fixing plate 22 is provided with through holes 23 so as to be screwed to the main body.

Further, three types of the light bars 4 (namely, light bars 4a to 4c) are attached to the heat radiation plate 21 using screws 24. More specifically, the light bar 4a (a first light bar), the light bar 4b (a second light bar), and the light bar 4c (a third light bar) are attached to the heat radiation plate 21 aligned in the longitudinal direction of the heat radiation plate 21 in order from the end surface without the fixing plate 22. In addition, each of the light bars 4 can be replaced (with a new one) independently of other light bars 4 by loosening the fixing screws 24.

The light bars 4 have the same size and substantially rectangular solid shape, and four LEDs 41 are aligned in the longitudinal direction of each light bar 4. Note that each light bar 4 is attached to the heat radiation plate 21 so that its longitudinal direction is agreed with the longitudinal direction of the heat radiation plate 21. Thus, an alignment direction of the light bars 4 and an alignment direction of the LEDs 41 are the same as the direction along the upper and lower edges of the light guide plate 15.

In addition, each light bar 4 is provided with connecters 42 (namely, connecters 42a to 42e) used for electrical connection with another light bar 4 or the like on the end surface sides in the longitudinal direction. More specifically, as illustrated in FIG. 5, the connecter 42a is disposed on one end side of the light bar 4a, the connecter 42b is disposed on one end side of the light bar 4b, the connecter 42c is disposed on the other end side of the light bar 4b, the connecter 42d is disposed on one end side of the light bar 4c, and the connecter 42e is disposed on the other end side of the light bar 4c.

Further, as illustrated in FIG. 5, when the light bar 4a and the light bar 4b are attached (positioned) to the heat radiation plate 21, the connecter 42a is connected to the connecter 42b. Similarly, when the light bar 4b and the light bar 4c are attached to the heat radiation plate 21, the connecter 42c is connected to the connecter 42d.

Note that the above-mentioned backlight driver 73 is provided with four connecters 13 corresponding to the individual (four) backlight units 2. The connecter 42e is connected to the connecter 13 corresponding to the backlight unit 2, manually, for example. By this connection, the backlight driver 73 can supply electric power to the individual backlight units 2.

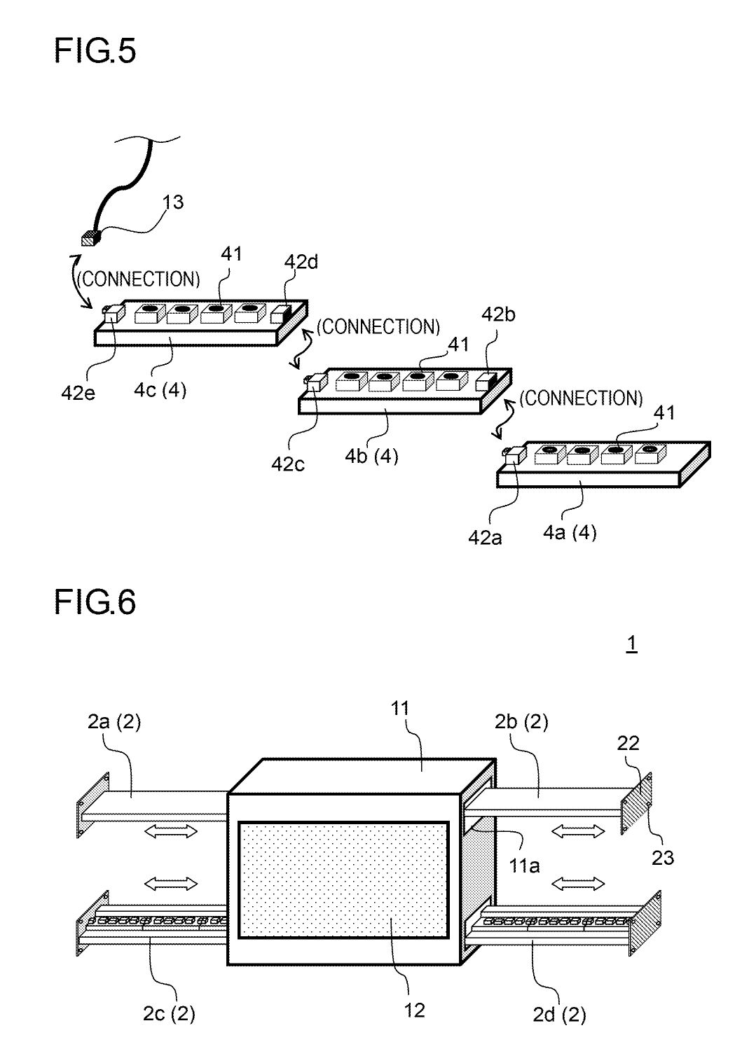

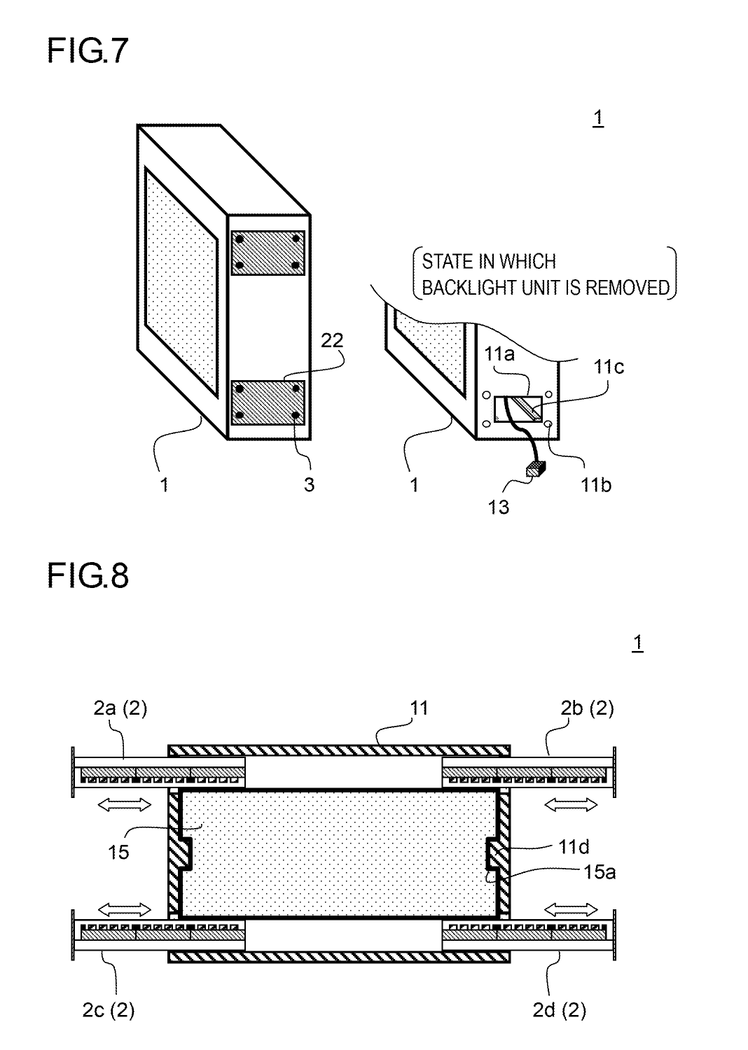

FIG. 6 illustrates a manner in which the individual backlight units 2 are detachable from the main body. In addition, FIG. 7 illustrates an external view of the image display apparatus 1 (illustrates mainly a right side face), in which the backlight units 2 are attached (the left in the diagram) and in which the backlight unit 2 is removed (the right in the diagram). As illustrated in this diagram, on the left and the right side faces of the housing 11, there are disposed opening portions 11a to which the backlight units 2 are inserted.

More specifically, at the upper part and the lower part on the left side face of the housing 11, there are formed the opening portions 11a to which the backlight unit 2a and the backlight unit 2c are inserted, respectively. In addition, at the upper part and the lower part on the right side face of the housing 11, there are formed the opening portions 11a to which the backlight unit 2b and the backlight unit 2d are inserted, respectively.

In addition, in vicinities of each opening portion 11a, there are formed screw holes 11b at positions corresponding to the through holes 23. The backlight unit 2 is normally screwed to the main body using the through holes 23 and the screw holes. In addition, inside the housing 11, there are disposed guide rails 11c so as to extend from each opening portion 11a to the direction along the upper and lower edges of the light guide plate 15. Each backlight unit 2 can be pushed in and pulled out to slide along the guide rail 11e in the direction illustrated in FIG. 6 by arrows. In addition, in each opening portion 11a, the connecter 13 can be pulled out so as to facilitate manual connection and disconnection between the connecter 42e and the connecter 13.

In addition, FIG. 8 is a cross sectional view similar to FIG. 2, which illustrates a manner in which the individual backlight units 2 are detachable from the main body. As illustrated in this diagram, each backlight unit 2 can slide in the left and right direction maintaining the state where the LEDs 41 face the light guide plate 15. In the state where all the backlight units 2 are inserted completely and fixed to the main body, namely in the state illustrated in FIG. 2, the upper face of the light guide plate 15 is opposed to the light bars 4 of 1ch to 6ch, and the lower face of the light guide plate 15 is opposed to the light bars 4 of 7ch to 12ch.

Note that as illustrated in FIG. 8, the left and the right ends of the light guide plate 15 are provided with recessed portions 15a, and protruding portions 11d of the housing 11 are fit in the recessed portions 15a. In this way, the light guide plate 15 is securely fixed to the housing 11 and does not move even if all the backlight units 2 are removed.

In addition, as apparent from FIGS. 2 and 4, the light bars 4c, 4b, and 4a attached to the backlight unit 2a correspond to 1ch, 2ch, and 3ch, respectively. In addition, the light bars 4a, 4b, and 4c attached to the backlight unit 2b correspond to 4ch, 5ch, and 6ch, respectively. In addition, the light bars 4c, 4b, and 4a attached to the backlight unit 2c correspond to 7ch, 8ch, and 9ch, respectively. In addition, the light bars 4a, 4b, and 4c attached to the backlight unit 2d correspond to 10ch, 11ch, and 12ch, respectively.

Next, a circuit structure of the various types of the light bars 4 will be described below with reference to FIGS. 9 to 11. Note that in this specification, for simple description, a part of a completed circuit (including a non-closed circuit) may also be referred to as a “circuit”.

FIG. 9 illustrates a circuit structure of the light bar 4a. The light bar 4a includes an LED circuit portion 48a constituted of four LEDs 41 connected in series. Further, the light bar 4a is provided with a line 43a for connecting one end (positive electrode side) of the LED circuit portion 48a to the connecter 42a, and a line 45a for connecting the other end (negative electrode side) of the LED circuit portion 48a to the connecter 42a.

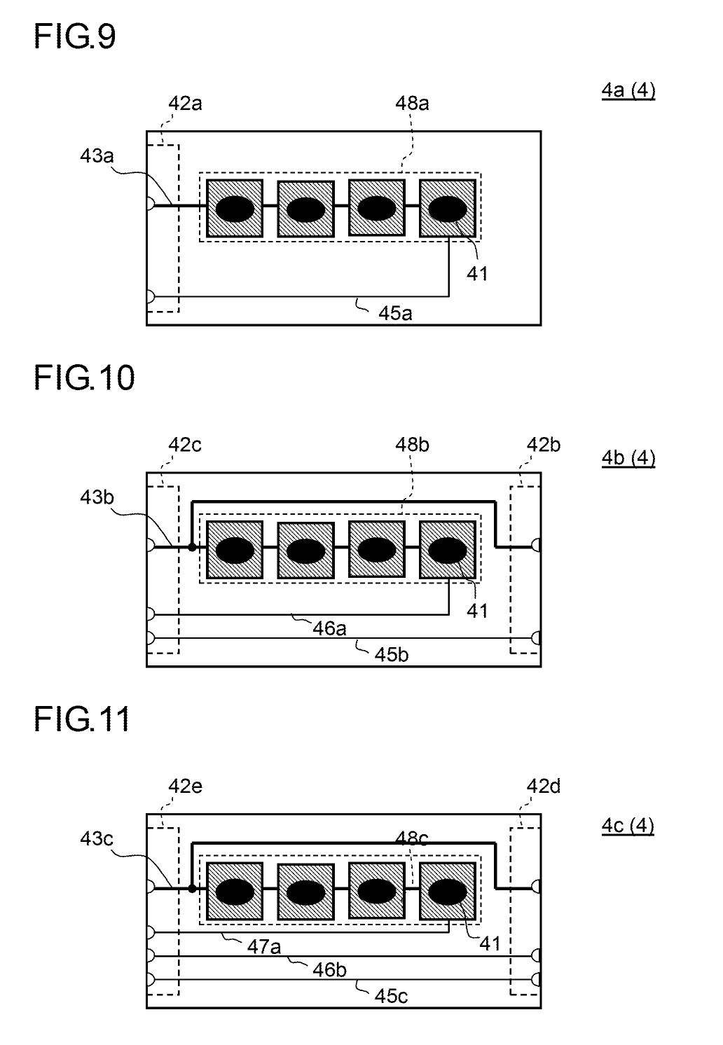

FIG. 10 illustrates a circuit structure of the light bar 4b. The light bar 4b includes an LED circuit portion 48b constituted of four LEDs 41 connected in series. Further, the light bar 4b is provided with a line 43b for connecting one end (positive electrode side) of the LED circuit portion 48b to the connecter 42b and the connecter 42c, and a line 46a for connecting the other end (negative electrode side) of the LED circuit portion 48b to the connecter 42c.

In addition, the light bar 4b is provided with a line 45b for connecting the connecter 42b to the connecter 42c. Thus, when the connecter 42a is connected to the connecter 42b, the line 43a is connected to the line 43b, and the line 45a is connected to the line 45b.

FIG. 11 illustrates a circuit structure of the light bar 4c. The light bar 4c includes an LED circuit portion 48c constituted of four LEDs 41 connected in series. Further, the light bar 4c is provided with a line 43c for connecting one end (positive electrode side) of the LED circuit portion 48c to the connecter 42d and the connecter 42e, and a line 47a for connecting the other end (negative electrode side) of the LED circuit portion 48c to the connecter 42e.

In addition, the light bar 4c is provided with a line 45c and a line 46b for connecting the connecter 42d to the connecter 42e. Thus, when the connecter 42c is connected to the connecter 42d, the line 43b is connected to the line 43c, the line 45b is connected to the line 45c, and the line 46a is connected to the line 46b. In addition, when the connecter 42e is connected to the connecter 13 of the main body side, each of the line 43c, the line 45c, the line 46b, and the line 47a is connected to the backlight driver 73.

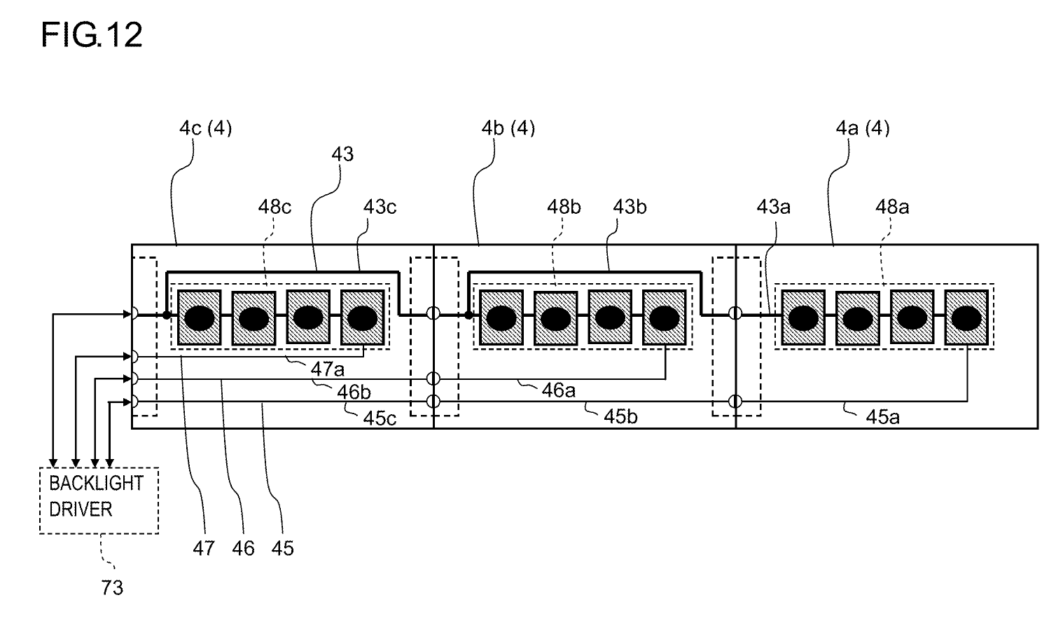

FIG. 12 illustrates a backlight circuit structure in the state where the light bars 4 are connected (namely, the state where the backlight unit 2 is completed as illustrated in FIG. 4). As illustrated in this diagram, the light bars 4 are united to form the backlight circuit when they are attached to the backlight unit 2. In the backlight circuit, the line 43a, the line 43b, and the line 43c are united to form a power supply line 43 for connecting the positive electrode sides of the LED circuit portions (48a to 48c) to the backlight driver 73 (main body side).

In addition, the line 45a, the line 45b, and the line 45c are united to form a feedback line 45 for connecting the negative electrode side of the LED circuit portion 48a to the backlight driver 73. In addition, the line 46a and the line 46b are united to form a feedback line 46 for connecting the negative electrode side of the LED circuit portion 48b to the backlight driver 73. In addition, the line 47a forms a feedback line 47 for connecting the negative electrode side of the LED circuit portion 48c to backlight driver 73.

On the other hand, the backlight driver 73 is connected to the power supply line 43 and the feedback lines (45 to 47) of each backlight unit 2. Note that twelve feedback lines connected to the backlight driver 73 correspond to the above-mentioned channels of 1ch to 12ch, respectively.

Then, the backlight driver 73 applies a predetermined voltage Vcc (for example, a constant voltage in a range of 18 to 25 V) to each power supply line 43 so as to supply electric current to the LEDs 41 using the power supply line 43 and the feedback lines (45 to 47). Then, the backlight driver 73 controls a current value for each feedback line in accordance with the signal for the backlight. Thus, the backlight luminance (light emission luminance of the LEDs 41) is controlled for each channel so that the local dimming is realized.

[Replacing Work of Light Bar]

Here, in the image display apparatus 1, a part or a whole of the LEDs 41 may be deteriorated or broken down after a long term use, for example. Or if the local dimming is performed for a long period of time, there may occur a difference in deterioration between LEDs 41 of different channels so as to generate a difference of backlight luminance.

However, according to the image display apparatus 1, even if such a malfunction has occurred, it is possible to fix the malfunction by replacing the light bar 4. In addition, if a luminance irregularity occurs only in a part of an image, namely, if it is considered that there is a malfunction only in an LED 41 in a channel corresponding to the part, only the light bar 4 of the channel is replaced so that wasteful replacement of the LEDs 41 (replacement of normal LEDs) can be suppressed.

The replacing work of the light bar is performed in a procedure as follows. First, screws 3 of the backlight unit 2 to which the light bar 4 to be replaced is attached are loosened, and the backlight unit 2 is pulled out from the main body. In this case, the connecter 42e is disconnected from the connecter 13 so that the pulling out can be performed more smoothly. At this stage, the light bar 4 to be replaced is exposed.

Next, the screws 24 of the light bar 4 to be replaced are loosened, and the light bar 4 is detached from the heat radiation plate 21. Then, a new light bar 4 having the same specification is attached to the place using the screws 24. After that, the connecter 42e is connected to the connecter 13, and the backlight unit 2 is inserted to the main body. Then, the screws 3 are fastened, and hence the replacing work is finished.

[Base Components of Light Bar]

As described above, there are three types (4a to 4c) of the light bars 4 that are attached to the same backlight unit 2. As illustrated in FIGS. 9 to 11, they have different circuit structures. However, in view of production efficiency of the light bars 4, it is preferred that the production steps be common as much as possible. For instance, it is preferred to produce a common base component (unfinished one of the light bar 4) that can be any types, and to complete the individual types of the light bars 4 (or components having the same functions as those) on the basis of the base component.

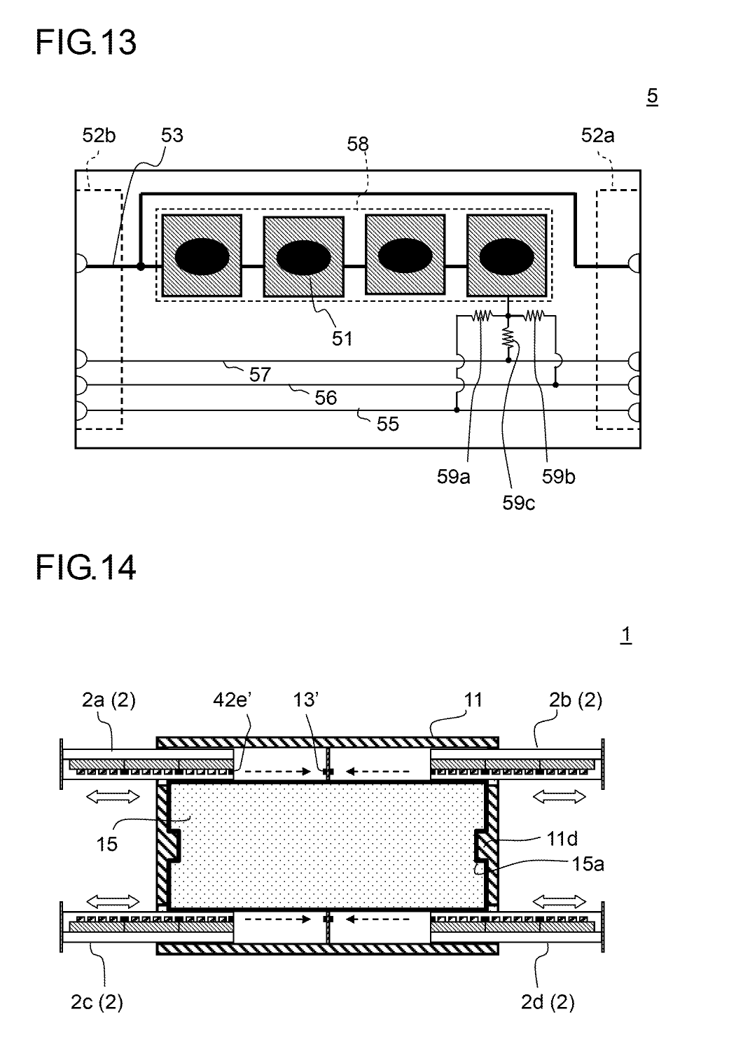

This base component will be described below with reference to a specific example in which the production efficiency is regarded to be important. FIG. 13 illustrates a structure of a base component 5. The base component 5 is formed in the same size as each light bar 4 and in a substantially rectangular solid shape. Four LEDs 51 (that are the same as the LEDs 41) are disposed to be aligned in the longitudinal direction of the base component 5. These LEDs 51 are connected in series so as to form an LED circuit portion 58.

In addition, the base component 5 is provided with connecters (52a and 52b) that are used for electrical connection with another light bar 4 or the like and are disposed at the end surfaces in the longitudinal direction thereof. More specifically, the connecter 52a is disposed at one end side of the base component 5, and the connecter 52b is disposed at the other end side of the base component 5.

Then, the base component 5 is provided with a line 53 for connecting one end (positive electrode side) of the LED circuit portion 58 to the connecter 52a and the connecter 52b. In addition, the base component 5 is provided with a line 55, a line 56, and a line 57 for connecting the connecter 52a to the connecter 52b.

In addition, the base component 5 is provided with jumper wires (59a to 59c) for connecting the other end (negative electrode side) of the LED circuit portion 58 to the lines (55 to 57). Note that the jumper wire 59a is used for connection to the line 55, the jumper wire 59b is used for connection to the line 56, and the jumper wire 59c is used for connection to the line 57. In addition, each of the jumper wires (59a to 59c) can be cut off so as to cancel the connection.

In addition, the connecter 52a and the connecter 52b are formed to correspond to each other. In other words, if there are two base components 5, the connecter 52a of one base component 5 and the connecter 52b of the other base component 5 can be connected to each other. Then, if the connecters (52a and 52b) are connected to each other, four lines (53 and 55 to 57) of the base components 5 are connected to each other, respectively. In addition, the connecter 52a and the connecter 52b are adapted to be connected also to the connecters 13 of the main body.

Using the base component 5 having the above-mentioned structure, it is possible to form components equivalent to the various types of the light bars as follows. First, the component equivalent to the light bar 4a (see FIG. 9) is formed by cutting off the jumper wires (59b and 59c) except the jumper wire 59a. Note that in this case, the connecter 52b corresponds to the connecter 42a, the line 53 corresponding to the line 43a, the jumper wire 59a and the line 55 correspond to the line 45a, and the LED circuit portion 58 corresponds to the LED circuit portion 48a.

In addition, the component equivalent to the light bar 4b (see FIG. 10) is formed by cutting off the jumper wires (59a and 59c) except the jumper wire 59b. Note that in this case, the connecter 52a corresponds to the connecter 42b, the connecter 52b corresponds to the connecter 42c, the line 53 corresponds to the line 43b, the line 55 corresponds to the line 45b, the jumper wire 59b and line 56 correspond to the line 46a, and the LED circuit portion 58 corresponds to the LED circuit portion 48b.

In addition, the component equivalent to the light bar 4c (see FIG. 11) is formed by cutting off the jumper wires (59a and 59b) except the jumper wire 59c. Note that in this case, the connecter 52a corresponds to the connecter 42d, the connecter 52b corresponds to the connecter 42e, the line 53 corresponds to the line 43c, the line 55 corresponds to the line 45c, the line 56 corresponds to the line 46b, the jumper wire 59c and the line 57 correspond to the line 47a, and the LED circuit portion 58 corresponds to the LED circuit portion 48c.

Note that the cutting of the jumper wires (59a to 59c) may be performed in the production stage of the light bar 4 (before shipping) or may be performed by a user or a worker of the image display apparatus 1 as appropriate. In addition, various means may be adopted as means for selectively connecting the LED circuit portion 58 to any one of the lines (55 to 57) other than the means using the jumper wires that can be cut off.

As described above, the base component 5 includes the LEDs 51, the line 53 (a first sub line) connected to one end of the LEDs 51, the line 55 (a first of second sub lines), the line 56 (a second of second sub lines), and the line 57 (a third of second sub lines) that are independent of each other. Further, the base component 5 is connected to another neighboring base component 5 so that the lines 53, the lines 55, the lines 56, and the lines 57 are connected to each other, respectively. In addition, by performing the process of connecting the other end of the LEDs 51 only to a K-th line (K=1, 2, or 3) of the lines 55, 56, or 57 (namely the cutting process of the jumper wires), the base component 5 forms a K-th light bar 4.

In addition, when the base component 5 is used, the power supply line 43 is formed by connecting the lines 53 to each other. In addition, the feedback line 45 is formed by connecting the lines 55 to each other. In addition, the feedback line 46 is formed by connecting the lines 56 to each other. In addition, the feedback line 47 is formed by connecting the lines 57 to each other.

[Others]

As described above, the image display apparatus 1 includes the main body in which the liquid crystal panel 12 (the display unit) is disposed, and the backlight units 2 that is detachable from the main body and to which three light bars 4 (LED module) are attached, each of which is provided with the LEDs 41. Light emitted from the LEDs 41 is used as backlight for displaying an image on the liquid crystal panel 12. Further, the three light bars 4 are individually assigned with different channels to be units of control of light emission luminance of the LED 41 and can be replaced independently of each other.

As a result, according to the image display apparatus 1, the LEDs 41 can be replaced by one channel by replacing the light bar 4. Therefore, it is easy to replace the LEDs 41 by one channel.

In addition, the embodiment of the present invention can be modified variously other than the above description, without deviating from the spirit of the present invention. For instance, various forms can be adopted concerning the number of the light bars 4 and the number of the LEDs 41. In addition, instead of the connection form between the main body and the backlight unit 2 using the connecter 13 and the connecter 42e (see FIG. 5), it is possible to adopt a connection form using a connecter 13′ and a connecter 42e′ as illustrated in FIG. 14.

Note that the connecter 42e′ has a similar function to the connecter 42e and is disposed at the end portion without the fixing plate 22 of the backlight unit 2. In addition, the connecter 13′ has a similar function to the connecter 13 and is disposed at the position corresponding to the connecter 42e′ inside the housing 11. According to this form, when the backlight unit 2 is attached to the main body (is fully inserted), the connecter 13′ is connected to the connecter 42e′ so that the backlight unit 2 is connected to the main body.

In addition, it is possible to adopt a direct illumination type backlight without limiting to the edge light type of this embodiment. Note that according to the image display apparatus of the present invention, the LEDs can be replaced by one channel by replacing the LED module. Therefore, it is easy to replace the LEDs by one channel.

What is claimed is:

1. An image display apparatus comprising:
a main body in which a display unit is disposed; and
a backlight unit that is detachable from the main body and to which a plurality of LED modules are attached, each of which is provided with LEDs, so that the image display apparatus displays an image on the display unit with backlight light emitted by the LEDs, wherein
the plurality of LED modules are assigned with different channels as units of control of light emission luminance of the LEDs and can be replaced independently of each other.

2. The image display apparatus according to claim 1, wherein
the plurality of LED modules are united to form a backlight circuit portion when the plurality of LED modules are attached to the backlight unit,
the backlight circuit portion is constituted of a first line for connecting one end of the LEDs to the main body and second lines provided individually for the LED modules, each of which connects the other end of the LEDs of the corresponding LED module to the main body, and
the main body supplies electric current to each of the LEDs using the first line and the second lines, while the main body controls a value of the electric current for each of the second lines so as to control light emission luminance of the LEDs.

3. The image display apparatus according to claim 2, wherein
the LED modules are disposed corresponding to different areas in a display screen of the display unit, and
backlight luminance is adjusted for each of the areas so that local dimming is realized.

4. The image display apparatus according to claim 3, wherein
a light guide plate is disposed behind the display unit, and
the backlight unit includes N (2□N) LED modules aligned along an edge of the light guide plate, so that the LED modules and the light guide plate constitute an edge light type backlight.

5. The image display apparatus according to claim 4, wherein
each of the LED modules includes a plurality of LEDs that are connected to each other in series and are aligned in the direction substantially the same as the direction in which the LED modules are aligned.

6. The image display apparatus according to claim 4, wherein
each of the LED modules is constituted using a common base component including LEDs, a first sub line connected to one end of the LEDs, and first to N-th of second sub lines,
the base component is constituted so that the first sub lines are connected to each other while the first to N-th of second sub lines are respectively connected to each other between neighboring base components, and that a process is performed on the base component for connecting the other end of the LED only to K-th (1□K□N) of the second sub lines, for forming the LED module disposed at K-th order in the alignment,
the first line is formed by connecting the first sub lines to each other, and
the second line is formed by connecting the second sub lines to each other.

7. The image display apparatus according to claim 5, wherein
each of the LED modules is constituted using a common base component including LEDs, a first sub line connected to one end of the LEDs, and first to N-th of second sub lines,
the base component is constituted so that the first sub lines are connected to each other while the first to N-th of second sub lines are respectively connected to each other between neighboring base components, and that a process is performed on the base component for connecting the other end of the LED only to K-th (1□K □N) of the second sub lines, for forming the LED module disposed at K-th order in the alignment,
the first line is formed by connecting the first sub lines to each other, and
the second line is formed by connecting the second sub lines to each other.
